(19) United States
(12) Patent Application Publication
(10) Pub. No.: US 2024/0019575 A1
(43) Pub. Date: Jan. 18, 2024

(54) SENSOR

(71) Applicant: Panasonic Intellectual Property Management Co., Ltd., Osaka (JP)

(72) Inventors: Yohei MORISHITA, Kanagawa (JP); Tomohiro MURATA, Kanagawa (JP); Naganori SHIRAKATA, Kanagawa (JP); Koji TAKINAMI, Kanagawa (JP); Mei OKAMOTO, Kanagawa (JP)

(21) Appl. No.: 18/356,012

(22) Filed: Jul. 20, 2023

Related U.S. Application Data
(63) Continuation of application No. PCT/JP2021/046617, filed on Dec. 16, 2021.

(30) Foreign Application Priority Data
Jan. 21, 2021 (JP) 2021-008039

(51) Int. Cl. G01S 17/04; B65G 43/00

(52) U.S. Cl. CPC G01S 17/04; B65G 43/00; B65G 2203/042

(57) ABSTRACT

This sensor includes: a sensing circuit for detecting an object moving along a path; a receiving circuit for receiving, from other sensors that have detected the object, identification information for the other sensors; and a control circuit for causing a storage circuit to store the most recently received identification information for another sensor in response to the detection of the object by the sensing circuit.

### TECHNICAL FIELD

The present disclosure relates to a sensor.

### BACKGROUND ART

Patent Literature (hereinafter referred to as “PTL”) 1 discloses a sensor network in which a plurality of sensors is arranged in a mesh form and performs radio communication with each other.

### CITATION LIST

### Patent Literature

PTL 1

Japanese Patent Application Laid-Open No. 2008-244756

### SUMMARY OF INVENTION

Incidentally, in a sensor network in which an article moving on a path such as a conveyor belt is detected, it is useful for the user to specify a sensor arrangement so as to specify a defect, for example, an article does not move properly.

In a case where the number of sensors is large, however, more labor is required when the sensors are caused to store a sensor arrangement relationship by a manual operation.

One non-limiting and exemplary embodiment facilitates providing a sensor capable of grasping an arrangement relationship automatically.

A sensor according to an exemplary embodiment of the present disclosure includes: sensing circuitry, which, in operation, performs detection of an article moving on a path; reception circuitry, which, in operation, performs reception of identification information on another sensor that has detected the article, the identification information on the other sensor being transmitted from the other sensor; and control circuitry, which, in operation, causes storage circuitry to store the identification information on the other sensor in response to the detection of the article by the sensing circuitry, the identification information on the other sensor having been most recently received.

A sensor according to an exemplary embodiment of the present disclosure includes: sensing circuitry, which, in operation, performs detection of an article moving on a path; reception circuitry, which, in operation, performs reception of identification information on another sensor, the identification information on the other sensor being transmitted in a case where the other sensor has detected the article; storage circuitry, which, in operation, stores upstream-side identification information on a next sensor, the next sensor being an immediately next sensor on an upstream side; and control circuitry, which, in operation, turns on the sensing circuitry after a lapse of a first time after receiving identification information matching the upstream-side identification information and turns off the sensing circuitry after a lapse of a second time.

It should be noted that general or specific embodiments may be implemented as a system, a method, an integrated circuit, a computer program, a storage medium, or any selective combination thereof.

According to an exemplary embodiment of the present disclosure, it is possible to grasp a sensor arrangement relationship automatically.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates an example of a configuration of a sensor network according to the present disclosure;

FIG. 2 illustrates an example of a block configuration of a sensor;

FIG. 3 illustrates an example of a table that is stored in a storer of the sensor;

FIG. 4 illustrates a timing chart provided for describing exemplary operations of sensors in calibration mode;

FIG. 5 illustrates a timing chart provided for describing exemplary operations of the sensors in normal mode;

FIG. 6 is a flowchart illustrating an exemplary operation of a first sensor;

FIG. 7A is a flowchart illustrating an exemplary operation of a second sensor; and

FIG. 7B is a flowchart illustrating the exemplary operation of the second sensor.

### DESCRIPTION OF EMBODIMENTS

Hereinafter, an embodiment of the present disclosure will be described in detail with reference to the accompanying drawings as appropriate. Having said that, a detailed description more than necessary may be omitted, such as a detailed description of an already well-known matter and a duplicated description for a substantially identical configuration, to avoid the following description becoming unnecessarily redundant and to facilitate understanding by a person skilled in the art.

Note that, the accompanying drawings and the following description are provided for a person skilled in the art to sufficiently understand the present disclosure, and are not intended to limit the subject matter described in the claims.

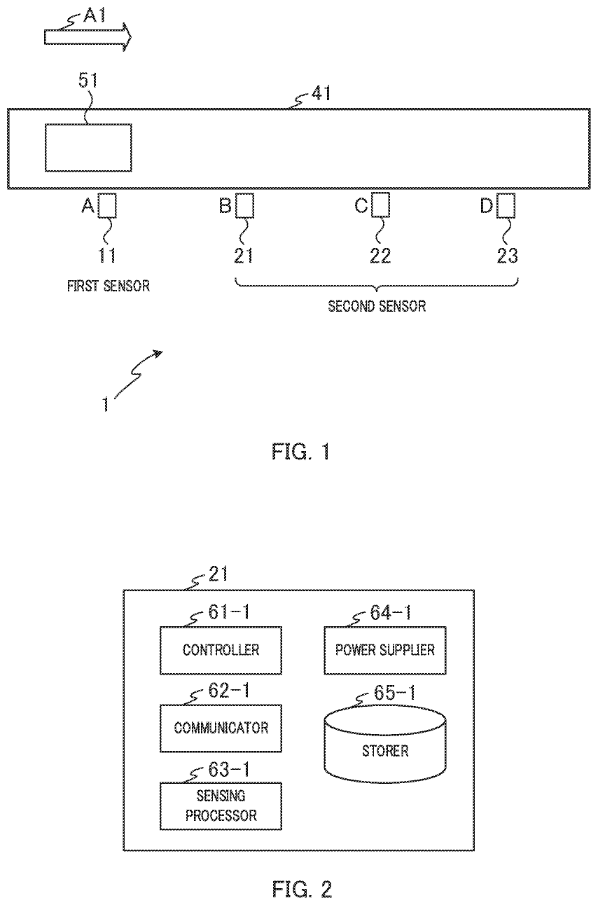

FIG. 1 illustrates an example of a configuration of sensor network 1 according to the present disclosure. As illustrated in FIG. 1, sensor network 1 includes sensors 11, 21, 22, and 23. Sensors 11, 21, 22, and 23 communicate with each other by using radio communication. As the radio communication, for example, radio communication such as Wi-Fi (registered trademark) or Bluetooth (registered trademark) may be used.

FIG. 1 illustrates, in addition to sensor network 1, conveyor belt 41 and article 51 that is transported by conveyor belt 41. Conveyor belt 41 transports article 51 at, for example, a factory or a distribution warehouse. Conveyor belt 41 transports article 51, for example, at a determined speed (constant speed).

In the example of FIG. 1, conveyor belt 41 transports article 51 in a direction of arrow A1. Accordingly, article 51 passes sensors 11, 21, 22, and 23 in the order of sensors 11, 21, 22, and 23. Note that, hereinafter, the direction of arrow A1 in the transportation direction of article 51 may be referred to as downstream. The direction opposite to the direction of arrow A1 may be referred to as upstream.

Sensors 11, 21, 22, and 23 are, for example, photoelectric sensors that are driven by a battery. Accordingly, sensors 11, 21, 22, and 23 do not require any wiring for power supply and communication. As illustrated as A to D in FIG. 1, for example, sensor-specific identification information (ID) is given to sensors 11, 21, 22, and 23.

Sensors 11, 21, 22, and 23 are arranged along conveyor belt 41 (along the transportation path of article 51). Sensors 11, 21, 22, and 23 detect the passage of article 51 flowing on conveyor belt 41, and monitors whether article 51 is properly transported on conveyor belt 41. For example, in a case where sensors 11, 21, 22, and 23 determine that article 51 is not properly transported, sensors 11, 21, 22, and 23 may sound the alarm.

In a case where sensors 11, 21, 22, and 23 detect the passage of article 51, sensors 11, 21, 22, and 23 broadcast passage detection information indicating that article 51 has passed. Sensors 11, 21, 22, and 23 receive the passage detection information that has been broadcast. Note that, the passage detection information may include a passage time at which article 51 has passed.

Sensors 11, 21, 22, and 23 are divided into first and second sensors. For example, among sensors 11, 21, 22, and 23, sensor 11 that first detects article 51 is configured to be the first sensor. In other words, among sensors 11, 21, 22, and 23, sensor 11 that is arranged at the head of the transportation path is configured to be the first sensor. Sensors 21, 22, and 23 other than the first sensor are configured to be the second sensors.

Note that, the number of sensors is not limited to the example in FIG. 1. For example, the number of second sensors may be equal to or greater than 1.

FIG. 2 illustrates an example of a block configuration of sensor 21. As illustrated in FIG. 2, sensor 21 includes controller 61-1, communicator 62-1, sensing processor 63-1, power supplier 64-1, and storer 65-1.

Controller 61-1 controls sensor 21 in its entirety. Controller 61-1 may be configured by a processor such as, for example, a central processing unit (CPU) or a digital signal processor (DSP). Further, controller 61-1 may have a timer function.

Communicator 62-1 communicates with sensors 11, 22, and 23 by using, for example, radio communication such as Wi-Fi or Bluetooth. Communicator 62-1 may also be configured by a receiver that receives a signal, and a transmitter that transmits a signal.

Sensing processor 63-1 detects the passage of article 51 flowing on conveyor belt 41. For example, sensing processor 63-1 may emit light, receive the reflected light, and detect the passage of article 51 based on the received light.

Power supplier 64-1 supplies power to each processor of sensor 21. For example, power supplier 64-1 supplies power to each processor of sensor 21 by using a battery such as a primary battery or a secondary battery. Note that, power supplier 64-1 may supply power with a wire or wirelessly.

Storer 65-1 stores a program for controller 61-1 to operate. Further, storer 65-1 stores data for controller 61-1 to perform calculation processing or data for controller 61-1 to control each processor. Storer 65-1 may be configured by storage apparatuses such as a random access memory (RAM), a read only memory (ROM), a flash memory, and a hard disk drive (HDD).

Note that, sensors 11, 22, and 23 also have the same block configuration as the block configuration illustrated in FIG. 2. Accordingly, the first sensor may be used as the second sensor, and the second sensor may be used as the first sensor.

Hereinafter, the controllers of sensors 11, 22, and 23 may be described as controllers 61-0, 61-2, and 61-3, respectively. The communicators of sensors 11, 22, and 23 may be described as communicators 62-0, 62-2, and 62-3, respectively. The sensing processors of sensors 11, 22, and 23 may be described as sensing processors 63-0, 63-2, and 63-3, respectively. The power suppliers of sensors 11, 22, and 23 may be described as power suppliers 64-0, 64-2, and 64-3, respectively. The storers of sensors 11, 22, and 23 may be described as storers 65-0, 65-2, and 65-3, respectively.

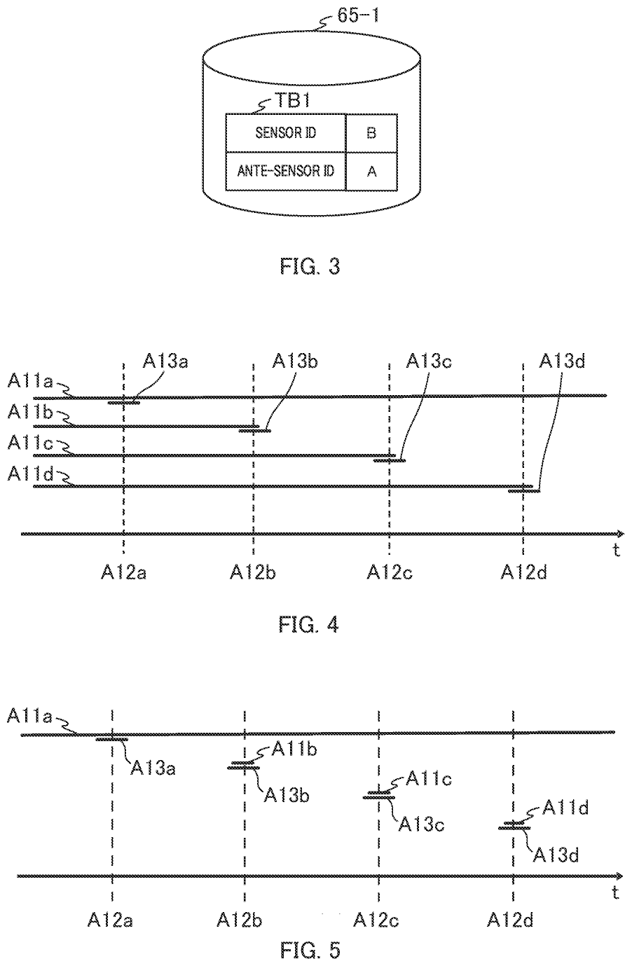

FIG. 3 illustrates an example of a table that is stored in storer 65-1 of sensor 21. As illustrated in FIG. 3, table TB1 includes a column of sensor ID and a column of ante-sensor ID.

The ID of sensor 21 is stored in the column of sensor ID. The B illustrated in FIG. 3 indicates the ID of sensor 21.

The ID of a sensor arranged immediately before sensor 21 in the transportation path (in the transportation direction of article 51) is stored in the column of ante-sensor ID.

For example, the sensor arranged immediately before sensor 21 in the transportation path in FIG. 1 is sensor 11. In other words, the sensor immediately before sensor 21 on an upstream side is sensor 11. Accordingly, the ID of sensor 11 is stored in the column of ante-sensor ID of table TB1. The A illustrated in FIG. 3 indicates the ID of sensor 11.

Note that, the sensor immediately before sensor 22 on an upstream side (immediately before sensor 22 in the transportation path) is sensor 21. Accordingly, the ID of sensor 21 is stored as the ante-sensor ID in storer 65-2 of sensor 22.

Further, the sensor immediately before sensor 23 on an upstream side is sensor 22. Accordingly, the ID of sensor 22 is stored as the ante-sensor ID in storer 65-3 of sensor 23.

There is no sensor on an upstream side of sensor 11 that is arranged at the head of the transportation path. Accordingly, for example, information indicating that there is no sensor may be stored as the ante-sensor ID in storer 65-0 of sensor 11.

Operations of sensors 11, 21, 22, and 23 will be described. Sensors 11, 21, 22, and 23 have operations in calibration mode and in normal mode.

In the calibration mode, sensors 11, 21, 22, and 23 grasp the arrangement of sensors 11, 21, 22, and 23. For example, each of sensors 11, 21, 22, and 23 grasps the ante-sensor ID thereof. For example, each of sensors 11, 21, 22, and 23 grasps the sensor immediately before each of sensors 11, 21, 22, and 23 on an upstream side in the transportation path.

In the normal mode, sensors 11, 21, 22, and 23 detect article 51 flowing on conveyor belt 41 and monitor whether article 51 is properly transported on conveyor belt 41. Further, the sensing processors of sensors 11, 21, 22, and 23 perform an on/off operation.

First, exemplary operations in the calibration mode will be described. FIG. 4 illustrates a timing chart provided for describing exemplary operations of sensors 11, 21, 22, and 23 in the calibration mode. The horizontal axis illustrated in FIG. 4 indicates time.

Timing A11a indicates the ON period of sensing processor 63-0 of sensor 11. Timing A11b indicates the ON period of sensing processor 63-1 of sensor 21. Timing A11c indicates the ON period of sensing processor 63-2 of sensor 22. Timing A11d indicates the ON period of sensing processor 63-3 of sensor 23.

Timing A12a indicates the communication timing of sensor 11. Timing A12b indicates the communication timing of sensor 21. Timing A12c indicates the communication timing of sensor 22. Timing A12d indicates the communication timing of sensor 23.

Timing A13a indicates the passage period of article 51 passing sensor 11. Timing A13b indicates the passage period of article 51 passing sensor 21. Timing A13c indicates the passage period of article 51 passing sensor 22. Timing A13d indicates the passage period of article 51 passing sensor 23.

Note that, the passage periods of article 51 passing sensors 11, 21, 22, and 23 may be regarded as periods during which sensors 11, 21, 22, and 23 can detect the passage of article 51. Further, article 51 may also be an article for testing that is caused to flow on conveyor belt 41 for calibration.

(1) Article 51 passes sensor 11 as indicated by timing A13a. Sensor 11 detects article 51 passing sensor 11.

Sensor 11 that has detected the passage of article 51 broadcasts arrangement-grasping-start information, passage detection information, and the ID of sensor 11. For example, sensor 11 broadcasts the arrangement-grasping-start information, the passage detection information, and the ID of sensor 11 at timing A12a.

Note that, in a case where there is transmission delay time Tdt between detection of the passage and transmission of the passage detection information, sensor 11 may include information on the extent of the delay in transmission after a detection start time in the passage detection information and transmit the passage detection information. Thus, second sensors 21, 22, and 23 can operate in view of transmission delay time Tdt in the case of timer reset.

(2) Sensors 21, 22, and 23 receive the arrangement-grasping-start information, the passage detection information, and the ID of sensor 11 that have been broadcast by sensor 11 at timing A12a. Sensors 21, 22, and 23 reset timers thereof (for example, to 0) in response to the reception of the arrangement-grasping-start information, the passage detection information, and the ID of sensor 11, and start time measurement.

Note that, in a case where sensors 21, 22, and 23 have received the arrangement-grasping-start information, sensors 21, 22, and 23 operate in the calibration mode.

(3) Article 51 passes sensor 21 as indicated by timing A13b. Sensor 21 detects article 51 passing sensor 21.

Sensor 21 that has detected the passage of article 51 stores the ID, which has been broadcast by sensor 11, as the ante-sensor ID in storer 65-1. Further, sensor 21 that has detected the passage of article 51 stores the time of the timer in storer 65-1. The time stored in storer 65-1 indicates the time between when article 51 passes sensor 11 and when article 51 passes sensor 21.

For example, storer 65-1 of sensor 21 stores information on the ante-sensor of sensor 21 (the ID of sensor 11) and the time between when article 51 passes sensor 11 and when article 51 passes sensor 21. Note that, the time stored in storer 65-1 may be referred to as a delay time or transportation time of article 51 between sensors. For example, the delay time for sensor 21 is the time between timing A12a and timing A12b. Note that, the delay time may be determined by second sensor 21 using the reception time of the passage detection information, transmission delay time Tdt, and the time of the timer.

Sensor 21 stores the ante-sensor ID and the delay time of article 51 in storer 65-1, and then broadcasts passage detection information and the ID of sensor 21 and turns off sensing processor 63-1. For example, sensor 21 broadcasts the passage detection information and the ID of sensor 21 at timing A12b and then turns off sensing processor 63-1 as indicated by timing A11b.

Note that, sensors 22 and 23 that do not detect article 51 continue the timer operation immediately before timing A12b.

(4) Sensors 22 and 23 receive the passage detection information and the ID of sensor 21 that have been broadcast by sensor 21 at timing A12b. Sensors 22 and 23 reset the timers thereof in response to the reception of the passage detection information and the ID of sensor 21 and start time measurement.

(5) Article 51 passes sensor 22 as indicated by timing A13c. Sensor 22 detects article 51 passing sensor 22.

Sensor 22 that has detected the passage of article 51 stores the ID, which has been broadcast by sensor 21, as the ante-sensor ID in storer 65-2. Further, sensor 22 that has detected the passage of article 51 stores the time of the timer in storer 65-2. The time stored in storer 65-2 indicates the time between when article 51 passes sensor 21 and when article 51 passes sensor 22.

For example, storer 65-2 of sensor 22 stores information on the ante-sensor of sensor 22 (the ID of sensor 21) and the time between when article 51 passes sensor 21 and when article 51 passes sensor 22.

Sensor 22 stores the ante-sensor ID and the delay time of article 51 in storer 65-2, and then broadcasts passage detection information and the ID of sensor 22 and turns off sensing processor 63-2. For example, sensor 22 broadcasts the passage detection information and the ID of sensor 22 at timing A12c and then turns off sensing processor 63-2 as indicated by timing A11c.

Note that, sensor 23 that does not detect article 51 continues the timer operation immediately before timing A12c.

(6) Sensor 23 receives the passage detection information and the ID of sensor 22 that have been broadcast by sensor 22 at timing A12c. Sensor 23 resets the timer thereof in response to the reception of the passage detection information and the ID of sensor 22 and starts time measurement.

(7) Article 51 passes sensor 23 as indicated by timing A13d. Sensor 23 detects article 51 passing sensor 23.

Sensor 23 that has detected the passage of article 51 stores the ID, which has been broadcast by sensor 22, as the ante-sensor ID in storer 65-3. Further, sensor 23 that has detected the passage of article 51 stores the time of the timer in storer 65-3. The time stored in storer 65-3 indicates the time between when article 51 passes sensor 22 and when article 51 passes sensor 23.

For example, storer 65-3 of sensor 23 stores information on the ante-sensor of sensor 23 (the ID of sensor 23) and the time between when article 51 passes sensor 22 and when article 51 passes sensor 23.

Sensor 23 stores the ante-sensor ID and the delay time of article 51 in storer 65-3, and then broadcasts passage detection information and the ID of sensor 23 and turns off sensing processor 63-3. For example, sensor 23 broadcasts the passage detection information and the ID of sensor 23 at timing A12d and then turns off sensing processor 63-3 as indicated by timing A11d.

As described above, each of sensors 21, 22, and 23 automatically stores the ante-sensor ID in the storer without depending on a manual operation. Further, each of sensors 21, 22, and 23 automatically stores the delay time between when article 51 passes the ante-sensor (the sensor immediately before each of sensors 21, 22, and 23 on an upstream side) and when article 51 passes each of sensors 21, 22, and 23 in the storer without depending on a manual operation.

Note that, in a case where sensors 21, 22, and 23 broadcast the passage detection information and the sensor IDs, sensors 21, 22, and 23 may turn on the transmission functions of communicators 62-1, 62-2, and 62-3, respectively. For example, sensors 21, 22, and 23 may store the ante-sensor IDs and the times of the timers (the delay times of article 51) in the storers, and then may turn on the transmission functions of communicators 62-1, 62-2, and 62-3, respectively, and broadcast the passage detection information and the sensor IDs. Then, sensors 21, 22, and 23 may broadcast these pieces of information and then may turn off the transmission functions of communicators 62-1, 62-2, and 62-3, respectively.

Further, the broadcasting may not be executed near the center of a passage period of article 51 (timings A13a to A13d) as indicated by timings A12a to A12d. The broadcasting may be executed between detection of article 51 and arrival of article 51 at the next sensor (the sensor immediately after the sensor, which has detected article 51, on a downstream side). At this time, sensors 21, 22, and 23 may include transmission delay time Tdt on the extent of the delay in transmission after a detection start time in the passage detection information and transmit the passage detection information.

Further, the ID of a sensor to be broadcast is the ID of a sensor that has detected the passage of article 51, and may be referred to as a passage ID.

Next, exemplary operations in the normal mode will be described. FIG. 5 illustrates a timing chart provided for describing exemplary operations of sensors 11, 21, 22, and 23 in the normal mode. The horizontal axis illustrated in FIG. 5 indicates time. In FIG. 5, those the same as in FIG. 4 are denoted by the same reference signs. Note that, it is assumed that storers 65-1, 65-2, and 65-3 of sensors 21, 22, and 23 store the ante-sensor IDs and delay times by calibration operations.

(1) Article 51 passes sensor 11 as indicated by timing A13a. Sensor 11 detects article 51 passing sensor 11. Note that, sensor 11 arranged at the head of the transportation path causes sensing processor 63-0 to be always-on as indicated by timing A11a.

Sensor 11 that has detected the passage of article 51 broadcasts passage detection information and the ID of sensor 11. For example, sensor 11 broadcasts the passage detection information and the ID of sensor 11 at timing A12a. Note that, sensor 11 may not broadcast arrangement-grasping-start information in the normal mode.

(2) Sensors 21, 22, and 23 receive the passage detection information and the ID of sensor 11 that have been broadcast by sensor 11. Sensors 21, 22, and 23 compare the received ID of sensor 11 and the ante-sensor IDs stored in storers 65-1, 65-2, and 65-3 whether the received ID of sensor 11 matches an ante-sensor ID stored in storers 65-1, 65-2, and 65-3.

(3) Among sensors 21, 22, and 23, a sensor for which the received ID of sensor 11 matches an ante-sensor ID stored in storers 65-1, 65-2, and 65-3 determines (calculates), based on the delay time stored in the storer, the timing at which the sensing processor is turned on and the time during which the sensing processor is on (the time between when the sensing processor is turned on and when the sensing processor is turned off).

Accordingly, sensor 21 immediately after sensor 11 (immediately after sensor 11 on a downstream side) that has detected article 51 determines, based on the delay time stored in storer 65-1 in the calibration mode, the timing (Tst) at which sensing processor 63-1 is turned on and the time (Ton) during which sensing processor 63-1 is on.

Note that, Tst and Ton that are determined based on a delay time can be considered to be the time (scheduled time), at which article 51 passes sensor 21 immediately after sensor 11 that has detected article 51, or as a part thereof. For example, it can be considered that sensor 21 immediately after sensor 11 that has detected article 51 determines, based on the delay time stored in storer 65-1 in the calibration mode, the scheduled time at which article 51 passes sensor 21, and determines the on-time of the sensing processor, where the on-time is the scheduled time or a part thereof.

Note that, the method of determining Tst and Ton will be described later. Further, hereinafter, a sensor immediately after a sensor that has detected article 51 may also be referred to as a post-sensor.

(4) Sensor 21 turns on sensing processor 63-1 based on Tst and Ton that have been determined. For example, sensor 21 turns on sensing processor 63-1 as indicated by timing A11b.

(5) Sensor 21 that has detected the passage of article 51 broadcasts passage detection information and the ID of sensor 21. For example, sensor 21 broadcasts the passage detection information and the ID of sensor 21 at timing A12b.

(6) Sensors 22 and 23 receive the passage detection information and the ID of sensor 21 that have been broadcast by sensor 21. Sensors 22 and 23 compare the received ID of sensor 21 and the ante-sensor IDs stored in storers 65-2 and 65-3 whether the received ID of sensor 21 matches an ante-sensor ID stored in storers 65-2 and 65-3.

(7) Between sensors 22 and 23, a sensor for which the received ID of sensor 11 matches an ante-sensor ID stored in storers 65-2 and 65-3 determines, based on the delay time stored in the storer, the timing at which the sensing processor is turned on and the time during which the sensing processor is on.

Accordingly, sensor 22 immediately after sensor 21 that has detected article 51 determines, based on the delay time stored in storer 65-2 in the calibration mode, the timing at which sensing processor 63-2 is turned on and the time during which sensing processor 63-2 is on.

(8) Sensor 22 turns on sensing processor 63-2 based on Tst and Ton that have been determined. For example, sensor 22 turns on sensing processor 63-2 as indicated by timing A11c.

(9) Sensor 22 that has detected the passage of article 51 broadcasts passage detection information and the ID of sensor 22. For example, sensor 22 broadcasts the passage detection information and the ID of sensor 22 at timing A12c.

(10) Sensor 23 receives the passage detection information and the ID of sensor 22 that have been broadcast by sensor 22. Sensor 23 compares the received ID of sensor 22 and the ante-sensor ID stored in storer 65-3 whether the received ID of sensor 22 matches the ante-sensor ID stored in storer 65-3.

(11) A sensor for which the received ID of sensor 22 matches the ante-sensor ID stored in the storer determines, based on the delay time stored in the storer, the timing at which the sensing processor is turned on and the time during which the sensing processor is on.

Accordingly, sensor 23 immediately after sensor 22 that has detected article 51 determines, based on the delay time stored in storer 65-3 in the calibration mode, the timing at which sensing processor 63-3 is turned on and the time during which sensing processor 63-3 is on.

(12) Sensor 23 turns on sensing processor 63-3 based on Tst and Ton that have been determined. For example, sensor 23 turns on sensing processor 63-3 as indicated by timing A11d.

(13) Sensor 23 that has detected the passage of article 51 broadcasts passage detection information and the ID of sensor 23. For example, sensor 23 broadcasts the passage detection information and the ID of sensor 23 at timing A12d.

As described above, sensors 21, 22, and 23 cause sensing processors 63-1, 63-2, and 63-3 to be on during Ton from Tst. Ton may be a constant value or may be changed depending on the detection time. The detection time is the time during which a sensor is detecting article 51 (the time between the start of detection and the end of detection). In a case where Ton is changed depending on the detection time, an ante-sensor includes the detection time of the ante-sensor in passage detection information and broadcasts the passage detection information.

An example of a method of determining Tst and Ton will be described. Tst may be determined by following equations 1 and 2.

Tst=detection start time+delay time−detection time/2 (Equation 1)

Ton=detection time×α (Equation 2)

Here, an arbitrary value with 0<α≤1 may be configured. The detection start time and the detection time can be grasped from passage detection information, and the delay time is stored at the time of the calibration operation. Note that, in a case where there is transmission delay time Tdt, the detection start time can be calculated with the reception time −Tdt.

Note that, in a case where the time between radio communication transmission by the communicator of a sensor and radio communication reception by the communicator of another sensor is relatively long, each sensor may configure, in view of delay Tdc (communication delay time) between radio communication transmission and radio communication reception, detection start time=reception time−Tdt−Tdc. Tdc may be grasped by radio transmission/reception of known data by each sensor in advance. Note that, in a case where the difference between the timer time of a sensor that performs radio transmission and the timer time of a sensor that performs a radio reception is small, the time of the timer for the radio transmission may be used as the detection start time.

As described above, sensing processor 63-1, 63-2 or 63-3 of, among sensors 21, 22, and 23, a sensor immediately after a sensor, which has been passed by article 51, on a downstream side is on for a predetermined time. For example, sensing processors 63-1, 63-2, and 63-3 of sensors 21, 22, and 23 perform an intermittent operation.

Note that, in a case where sensors 21, 22, and 23 broadcast the passage detection information and the IDs of sensor 21, 22, 23, sensors 21, 22, and 23 may turn on the transmission functions of communicators 62-1, 62-2, and 62-3, respectively. For example, after Tst and Ton determination, sensors 21, 22, and 23 may turn on the transmission functions of communicators 62-1, 62-2, and 62-3, respectively, and broadcast the passage detection information and the sensor IDs, respectively. Then, sensors 21, 22, and 23 may broadcast these pieces of information and then may turn off the transmission functions of communicators 62-1, 62-2, and 62-3, respectively.

Further, the broadcasting may not be executed near the center of a passage period of article 51 (timings A13a to A13d) as indicated by timings A12a to A12d. The broadcasting may be executed between detection of article 51 and arrival of article 51 at the post-sensor. At this time, the sensor may include transmission delay time Tdt as information on the extent of the delay in transmission after a detection start time in the passage detection information and transmit the passage detection information.

Further, the ID of a sensor to be broadcast is the ID of a sensor that has detected the passage of article 51, and may be referred to as a passage ID.

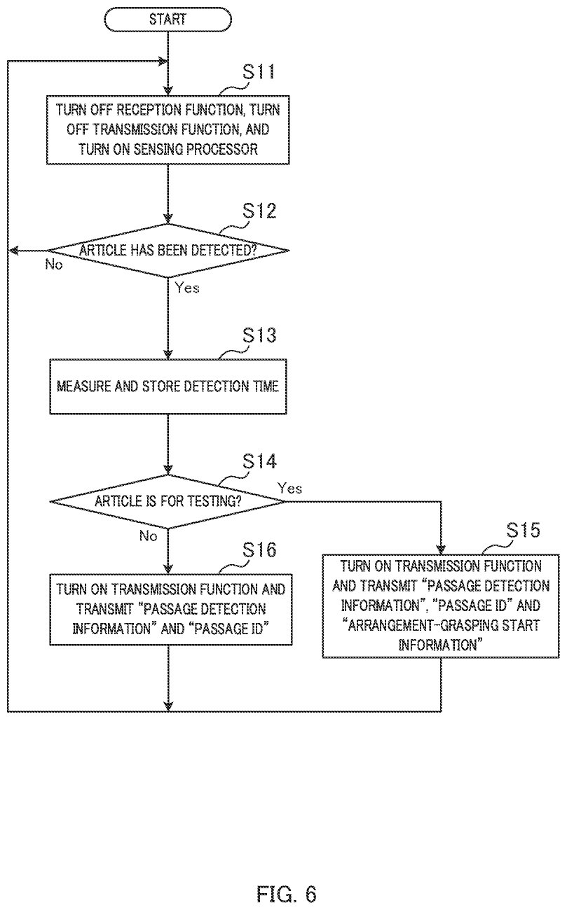

FIG. 6 is a flowchart illustrating an exemplary operation of the first sensor. The first sensor turns off the reception function of the communicator and turns off the transmission function (S11). Further, the first sensor turns on the sensing processor (S11).

The first sensor determines whether the first sensor has detected article 51 (S12).

In a case where the first sensor determines that the first sensor has not detected article 51 (“No” in S12), the first sensor causes the processing to proceed to S11.

In a case where the first sensor determines that the first sensor has detected article 51 (“Yes” in S12), the first sensor measures the detection time of article 51 (the time during which the first sensor is detecting article 51) and stores the detection time in the storer (S13).

The first sensor determines whether article 51 that has been detected is for testing (S14). Whether article 51 flowing on conveyor belt 41 is for testing may be determined, for example, based on the shape (length) of the object to be detected, may be configured to the first sensor by the user, or may be configured by communication after turning on the communication reception function in S11. The number of passing articles may be counted and those that have passed in a designated order may be used for testing.

In a case where the first sensor determines that article 51 which has been detected is for testing (“Yes” in S14), the first sensor turns on the transmission function of the communicator and broadcasts passage detection information including the detection time stored in S13, a passage ID (the ID of the first sensor), and arrangement-grasping-start information (S15). For example, in a case where the first sensor determines that article 51 which has been detected is for testing, the first sensor operates in the calibration mode.

In a case where the first sensor determines that article 51 which has been detected is not for testing (“No” in S14), the first sensor turns on the transmission function of the communicator and broadcasts passage detection information including the detection time stored in S13 and a passage ID (the ID of the first sensor) (S16). For example, in a case where the first sensor determines that article 51 which has been detected is not for testing, the first sensor operates in the normal mode.

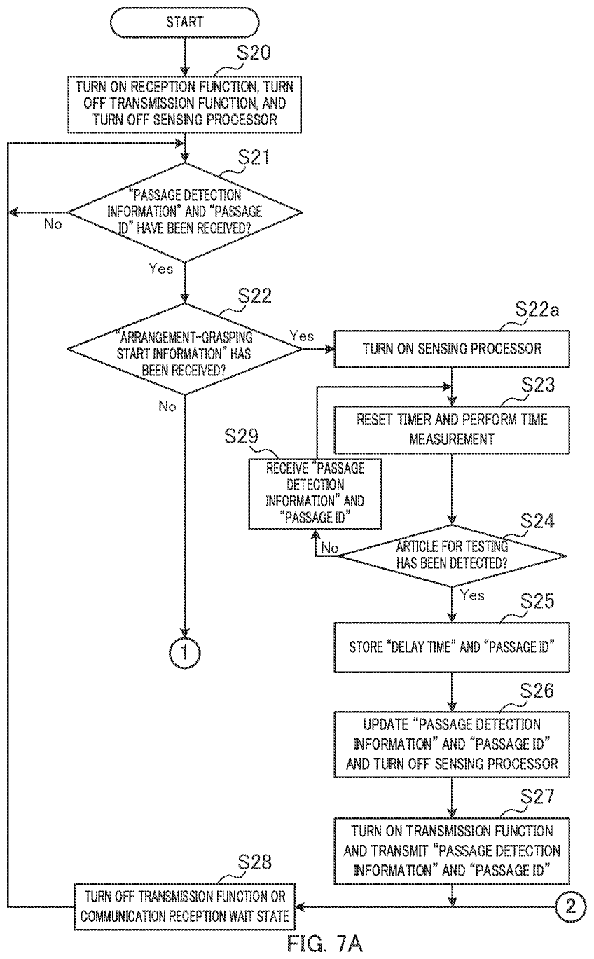

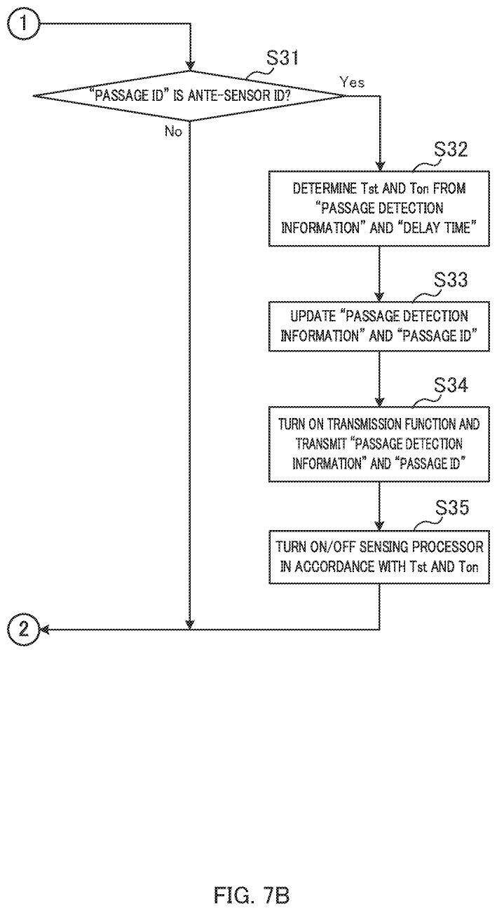

FIGS. 7A and 7B are flowcharts illustrating an exemplary operation of the second sensor. In the flowchart illustrated in FIGS. 7A and 7B, the processing continues at numbers 1 and 2 that have been circled. Hereinafter, it is assumed that the passage detection information includes a passage time.

The second sensor turns on the reception function of the communicator and turns off the transmission function thereof (S20). Further, the second sensor turns off the sensing processor (S20).

The second sensor determines whether the second sensor has received passage detection information and a passage ID (a sensor ID broadcast by an ante-sensor) (S21).

In a case where the second sensor determines that the second sensor has received passage detection information and a passage ID (“Yes” in S21), the second sensor further determines whether the second sensor has received arrangement-grasping-start information (S22).

In a case where the second sensor determines that the second sensor has received passage detection information, a passage ID, and arrangement-grasping-start information (“Yes” in S22), the second sensor turns on the sensing processor (S22a).

The second sensor resets the timer and performs time measurement (S23). For example, in a case where the second sensor has received passage detection information, a passage ID, and arrangement-grasping-start information, the second sensor operates in the calibration mode.

The second sensor determines whether the second sensor has detected article 51 for testing (S24).

The second sensor that has detected article 51 for testing in S24 stores, as a delay time, the time of the timer, whose measurement has been started in S23, in the storer (S25). Further, the second sensor that has detected article 51 for testing in S24 stores a passage ID, which has been broadcast by another second sensor (the sensor ID of the other second sensor), in the storer (S25). For example, the second sensor that has detected article 51 for testing in S24 stores the most recent passage ID broadcast by another second sensor.

The second sensor updates the passage time included in the passage detection information (updates the passage time to the time at which article 51 for testing has been detected in S24) and updates the passage ID to the own sensor ID of the second sensor (the sensor ID of the second sensor that has detected article 51 for testing) (S26). Further, the second sensor that has detected article 51 for testing in S24 turns off the sensing processor (S26).

The second sensor that has executed the processing in S25 turns on the transmission function of the communicator and broadcasts the passage detection information and the passage ID that have been updated in S26 (S27).

The second sensor that has broadcast the passage detection information and the passage ID in S27 turns off the transmission function (S28).

In a case where the second sensor has not detected article 51 for testing in S24 (“No” in S24), the second sensor receives passage detection information and a passage ID that have been broadcast by another second sensor that has detected article 51 for testing (S29). The second sensor that has received the passage detection information and the passage ID in S29 causes the processing to proceed to S23, resets the timer, and performs time measurement.

The second sensor that determines in S21 that the second sensor has not received passage detection information, a passage ID, and arrangement-grasping-start information (“No” in S21) enters a communication reception wait state (between S20 and S21) (S28).

In a case where the second sensor determines in S22 that the second sensor has not received arrangement-grasping-start information (“No” in S22), the second sensor determines whether the received passage ID matches the ante-sensor ID stored in the storer (S31 of FIG. 7B). For example, in a case where the second sensor has received passage detection information and a passage ID, the second sensor operates in the normal mode.

In a case where the second sensor determines that the received passage ID matches the ante-sensor ID stored in the storer (“Yes” in S31), the second sensor determines Tst and Ton based on the passage detection information (the detection time included in the passage detection information) and the delay time stored in the storer (S32).

The second sensor updates the passage time included in the passage detection information (updates the passage time to the time at which the sensing processor has detected article 51) and updates the passage ID to the own sensor ID of the second sensor (the sensor ID of the second sensor that has detected article 51 for testing) (S33).

The second sensor turns on the transmission function of the communicator and broadcasts the passage detection information and the passage ID that have been updated in S33 (S34).

The second sensor turns on the sensing processor in accordance with Tst and Ton that have been determined in S32 (S35). The second sensor turns on the sensing processor and then causes the processing to proceed to S28.

Note that, the order of the operations in S33 to S35 may be changed. The second sensor may update and transmit passage detection information and a passage ID while or before and after the sensing processor is on.

In a case where the second sensor determines in S31 that the received passage ID does not match the ante-sensor ID stored in the storer (“No” in S31), the second sensor causes the processing to proceed to S28.

As described above, sensor 21 includes: sensing processor 63-1 that performs detection of article 51 flowing on conveyor belt 41; communicator 62-1 that receives a sensor ID that is transmitted in a case where another sensor 11, 22 or 23 has detected article 51; and controller 61-1 that causes storer 65-1 to store another sensor ID, which has been most recently received, in response to the detection of article 51 by sensing processor 63-1.

As described above, in a case where sensing processor 63-1 has detected article 51, sensor 21 stores the most recently received sensor ID in storer 65-1. For example, storer 65-1 stores identification information on an immediately next sensor on an upstream side in conveyor belt 41. The same applies to other sensors 22 and 23 that form sensor network 1, and the storers of sensors 22 and 23 store identification information on an immediately next sensor on an upstream side in conveyor belt 41.

Accordingly, sensors 21, 22, and 23 can grasp a sensor arrangement relationship automatically. Further, the user can easily grasp a sensor arrangement order.

Further, as described above, sensor 21 includes: sensing processor 63-1 that performs detection of article 51 flowing on conveyor belt 41; communicator 62-1 that receives a sensor ID that is transmitted in a case where another sensor 11, 22 or 23 has detected article 51; storer 65-1 that stores identification information on an immediately next sensor on an upstream side; and controller 61-1 that, in a case where the received sensor ID matches the identification information stored in storer 65-1, turns on sensing processor 63-1 at a predetermined timing (Tst) and turns off sensing processor 63-1 after a predetermined time (Ton), after the sensor ID is received.

As described above, in a case where the sensor ID transmitted by another sensor 11, 22 or 23 is the identification information on sensor 11 as an immediately next sensor on an upstream side in conveyor belt 41, sensor 21 turns on sensing processor 63-1 at a predetermined timing and turns off sensing processor 63-1 after a predetermined time, after the sensor ID of sensor 11 is received. For example, sensor 21 turns on sensing processor 63-1 after article 51 passes sensor 11 as an immediately next sensor on an upstream side in conveyor belt 41, and turns off sensing processor 63-1 after a predetermined time.

Accordingly, sensor 21 can suppress power consumption in comparison with a case where sensing processor 63-1 is caused to be always-on.

Note that, the second sensor may receive passage detection information on second article 51 before first article 51 arrives. In this case, the second sensor stores passage detection information on first article 51 and the passage detection information on second article 51 in the storer and turns on the sensing processor based on the respective pieces of passage detection information. For example, the second sensor may store passage detection information on article 51, which does not pass the second sensor, in the storer and turn on the sensing processor based on the passage detection information stored in the storer.

Further, the detection time in equation 1 may be 0. For example, the second sensor may turn on the sensing processor based on passage detection information and a delay time.

Further, the first sensor can calculate the length of article 51 to be transported in the case of always-on. For example, the first sensor can calculate the length of article 51 from a detection time and the speed of article 51 transported by conveyor belt 41.

The first and second sensors may include the length of article 51 calculated by the first sensor in passage detection information and broadcast the passage detection information. The second sensor may use the length of article 51 to determine Tst and Ton. Further, passage detection information may include not the length of article 51, but the start and end times of the passage of article 51. The broadcasting of passage detection information may be performed twice, namely when the passage of article 51 starts and the passage of article 51 ends.

Further, the order of all sensors and a delay time from an ante-sensor may be stored in one or more sensors or may be stored in another storage apparatus such as a server. Abnormalities of the transportation of article 51 may be monitored and a location where abnormality of the transportation occurs may be specified from the stored order of all sensors and the stored delay time from the ante-sensor. Further, in a case where the speed of movement of article 51 is known, abnormality of the transportation may be detected based on a passage time predicted from a stored delay time and an actual passage time at the time of the operation.

Further, the calibration mode may be used for grasping a sensor arrangement without determining a delay time.

Further, although it has been described above that the first and second sensors perform radio communication, the first and second sensors may perform wired communication. Even in the case of wired communication, the first and second sensors can grasp a sensor arrangement. Further, the second sensor can suppress power consumption of a wired sensor network by an intermittent operation.

Further, the sensing processor of the first sensor may not be turned always-on. For example, the sensing processor of the first sensor may be turned on at a timing at which a person who inputs an article inputs the article to conveyor belt 41. Then, the first sensor may be turned off after detecting the article.

Further, among the plurality of sensors that configures sensor network 1, a sensor that first detects an article for testing may be determined as the first sensor. The sensor determined as the first sensor may broadcast arrangement-grasping-start information.

In this case, the plurality of sensors that configures sensor network 1 may have an arrangement grasping flow and an article monitoring flow.

For example, in the arrangement grasping flow, a sensor that first detects an article for testing is the first sensor that broadcasts arrangement-grasping-start information and is always-on. Other sensors are the second sensors that perform an intermittent operation.

Further, in the arrangement grasping flow, the second sensor may receive and store the sensor ID of an ante-sensor and a delay time in the transportation of an article from the ante-sensor.

In the article monitoring flow, the first sensor may be always-on, and the second sensor may perform an intermittent operation.

The second sensor may determine the timing at which the sensing processor is turned on and the on-time, based on passage detection information and a passage ID, which are transmitted by each sensor when an article passes each sensor, an ante-sensor ID stored in the storer, and a delay time from an ante-sensor.

Further, the communicator of a sensor may perform radio transmission of information to be broadcast in a range in which the information reaches an adjacent sensor.

Further, sensor network 1 described above is a distribution system in which each of sensors 11, 21, 22, and 23 operates autonomously in accordance with a determined flow. In sensor network 1, the hardware can be the same, and replacement of sensors 11, 21, 22, and 23 is also facilitated.

Further, sensors 11, 21, 22, and 23 may broadcast a sensor ID (passage ID) and may not broadcast passage detection information. Sensors 11, 21, 22, and 23 may notify another sensor of detection of article 51 by broadcasting a sensor ID.

In the embodiment described above, the notation “ . . . processor”, “−er”, “−or”, and “−ar” used for each component may be replaced with another notation such as “ . . . circuitry”, “ . . . assembly”, “ . . . device”, . . . . unit” or “ . . . module”.

Although the embodiment has been described thus far with reference to the accompanying drawings, the present disclosure is not limited to the given examples. It is apparent that a person skilled in the art is able to arrive at various changes or modifications within the scope described in the claims. It should be understood that such changes or modifications also belong to the technical scope of the present disclosure. Further, the components in the embodiment may be arbitrarily combined without departing from the spirit of the present disclosure.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a field programmable gate array (FPGA) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. Some non-limiting examples of such a communication apparatus include a phone (e.g., cellular (cell) phone, smartphone), a tablet, a personal computer (PC) (e.g., laptop, desktop, notebook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The sensor is not limited to be portable or movable, and may also include any kind of apparatus, device or system being not easily portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof. The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus may also include an infrastructure facility, such as a base station, an access point, and any other apparatus, device or system that communicates with or controls apparatuses such as those in the above non-limiting examples.

The disclosure of Japanese Patent Application No. 2021-008039, filed on Jan. 21, 2021, including the specification, drawings and abstract, is incorporated herein by reference in its entirety.

### INDUSTRIAL APPLICABILITY

The present disclosure is useful for a sensor that detects an object moving on a path.

### REFERENCE SIGNS LIST

1 Sensor network
11,21,22,23 Sensor
41 Conveyor belt
51 Article
61-1 Controller
62-1 Communicator
63-1 Sensing processor
64-1 Power supplier
65-1 Storer
TB1 Table

1. A sensor, comprising:
sensing circuitry, which, in operation, performs detection of an article moving on a path;
reception circuitry, which, in operation, performs reception of identification information on another sensor that has detected the article, the identification information on the other sensor being transmitted from the other sensor; and
control circuitry, which, in operation, causes storage circuitry to store the identification information on the other sensor in response to the detection of the article by the sensing circuitry, the identification information on the other sensor having been most recently received.

2. The sensor according to claim 1, further comprising transmission circuitry, which, in operation, transmits identification information on the sensor in a case where the sensing circuitry has detected the article.

3. The sensor according to claim 1, wherein the control circuitry turns off the sensing circuitry after the sensing circuitry detects the article.

4. The sensor according to claim 1, wherein the control circuitry measures a time between the reception of the identification information on the other sensor and the detection of the article by the sensing circuitry and stores the time in the storage circuitry.

5. The sensor according to claim 4, wherein in a case where the identification information received by the reception circuitry matches the identification information stored in the storage circuitry, the control circuitry turns on the sensing circuitry at a predetermined timing determined based on the time and turns off the sensing circuitry after a predetermined time, after the reception of the identification information by the reception circuitry.

6. A sensor, comprising:
sensing circuitry, which, in operation, performs detection of an article moving on a path;
reception circuitry, which, in operation, performs reception of identification information on another sensor, the identification information on the other sensor being transmitted in a case where the other sensor has detected the article;
storage circuitry, which, in operation, stores upstream-side identification information on a next sensor, the next sensor being an immediately next sensor on an upstream side; and
control circuitry, which, in operation, turns on the sensing circuitry after a lapse of a first time after receiving identification information matching the upstream-side identification information and turns off the sensing circuitry after a lapse of a second time.

7. The sensor according to claim 6, wherein the first time is determined based on a time measured in advance between detection of the article by the next sensor and the detection of the article by the sensing circuitry.
